(19) United States
(12) Patent Application Publication
(10) Pub. No.: US 2022/0248739 A1
(43) Pub. Date: Aug. 11, 2022

(54) Non-digestible oligosaccharides for decreased colonic protein fermentation

(71) Applicant: N.V. Nutricia, Zoetermeer (NL)

(72) Inventors: Jan Knol, Utrecht (NL); Kaouther Ben Amor, Utrecht (NL)

(73) Assignee: N.V. Nutricia, Zoetermeer (NL)

(21) Appl. No.: 17/613,965

(22) PCT Filed: May 29, 2020
(86) PCT No.: PCT/EP2020/065019

§ 371 Date: Nov. 24, 2021

(30) Foreign Application Priority Data
May 29, 2019 (EP) 19177274.8

(51) Int. Cl. A23L 33/21; A23L 33/00

(52) U.S. Cl. CPC A23L 33/21; A23V 2200/32; A23L 33/40

(57) ABSTRACT

The present invention relates to an infant formula comprising non digestible oligosaccharides for reducing or preventing proteolytic fermentation in the gastro-intestinal tract.

### FIELD OF THE INVENTION

The present invention is in the field of nutrition for infants and young children and concerns nutrition for decreasing colonic protein fermentation.

### BACKGROUND OF THE INVENTION

It is generally accepted that the microbial ecosystem inhabiting the gut profoundly affects human physiology and health. In that respect excessive proteolytic fermentation is often mentioned as having a correlation with several adverse conditions. Proteolytic fermentation affects the gut microbiome and it generates a wide range of bioactive molecules. Proteolytic fermentation has been associated with inflammatory response, undesired tissue permeability, and with severity of colitis in the gut. Moreover proteolytic fermentation is also implicated in the development of metabolic disease, including obesity, diabetes, and non-alcoholic fatty liver disease (Diether et al., Microorganisms 2019, 7). Also specific metabolites of proteolytic fermentation such as ammonia, p-cresol, phenol and hydrogen sulphide have been correlated with colorectal cancer (Windey et al., Mol. Nutr. Food Res. 2012, 56, 184-196).

In the process of digestion, excess protein and protein fragments that are not digested in the small intestine enters the large intestine and is fermented by the microbiome present. The fermentation predominantly takes place in the distal colon as most saccharides are depleted in this part of the digestive tract. In general the microbiome adapts to the nutrients that are offered. Therefore, in case protein fermentation is increased, proteolytic species, amongst which Klebsiella and Enterobacter, will be more dominant. To study proteolytic fermentation, use is made of some metabolites that are unique for proteolytic fermentation such as branched short chain fatty acids (BSCFA). BCSFA may lead to intestinal gas production providing an undesirable gut ecology. In the digestive tract proteolytic fermentation is the only source for BSCFA.

As proteolytic fermentation in the gastro-intestinal tract in general is undesirable, methods for decreasing proteolytic fermentation have been proposed. WO 2018/215189 A1 discusses a combination of two human milk oligosaccharides (HMOs) for decreasing detrimental proteolytic metabolites. WO 2018/215960 A1 concerns the same purpose and discloses a neutral HMO. WO 2011/060123 A1 discloses a combination of long chain and short chain fructo-oligosaccharides and acacia gum for decreasing proteolytic fermentation.

So far the main focus related to non-digestible oligosaccharides has been towards positive stimulation of the microbiome. For example for the mixture of galacto-oligosaccharides and fructo-oligosaccharides the bifidogenic effect and effect on pathogens in the gastro-intestinal tract is known (Fanaro et al. Acta Pdiatrica, 2005; 94 (Suppl. 449)). However, the effect on proteolytic fermentation has not been studied.

The gastro-intestinal tract and the microbiome of an infant is under development. A tight regulation of protein intake is often advised as protein is digested less efficiently in an infant and excess protein will lead to undesired protein fermentation. Also the presence of microbial proteases as a consequence of protein fermentation in the large intestine may affect the infant as this could lead to colonic pain and impaired barrier function (Abrahamse et al., J. of Nutr. 2015, 145(7)).

### SUMMARY OF THE INVENTION

There is a need for compositions to reduce or prevent protein proteolytic fermentation in the gastro-intestinal tract. There is a special need for infants, as their gastro-intestinal tract is still under development.

The inventors now surprisingly found that a nutritional composition comprising galacto-oligosaccharides (GOS) and fructo-oligosaccharides (FOS) and fucosylated non-digestible human milk oligosaccharides, in particular fucosyllactose, more in particular 2′-fucosyllactose (2′-FL) reduces or prevents proteolytic fermentation in the gastro-intestinal tract of a subject. Detrimental effects related to proteolytic fermentation are therewith reduced of prevented. This effect was not known or suggested. In an in vitro gastro-intestinal model (SHIME) it was found that through administering a composition comprising GOS and FOS and 2′-FL the amount of proteobacteria, preferably proteolytic bacteria, is greatly reduced. Moreover also the level of iso-butyrate, an exclusive metabolite of proteolytic fermentation reduces considerably.

The inventors surprisingly found that a fucosylated non-digestible human milk oligosaccharide, in particular fucosyllactose, more in particular 2′-FL has almost no effect on proteolytic fermentation. The in vitro gastro-intestinal model demonstrates that the amount of proteobacteria, preferably proteolytic bacteria, and the level of iso-butyrate are hardly affected by a fucosylated non-digestible human milk oligosaccharide. However, surprisingly, when such fucosylated non-digestible human milk oligosaccharide was combined with a GOS/FOS mixture the effect on proteolytic fermentation and on the level of proteobacteria, preferably proteolytic bacteria, is larger than the effect of the GOS/FOS mixture alone, especially with regard to iso-butyrate formation and Enterobacter reduction.

Fucosylated non-digestible human milk oligosaccharide, in particular fucosyllactose, more in particular 2′-FL, form a substantial part of human milk. Fucosylated non-digestible human milk oligosaccharide and especially 2′-FL, has been associated with anti-adhesive antimicrobial effects, modulation of intestinal epithelial cell response, effects on immune development and on brain development.

### DETAILED DESCRIPTION OF THE INVENTION

Thus the present invention concerns a combination of galacto-oligosaccharides, fructo-oligosaccharides and fucosylated non-digestible human milk oligosaccharides for use in reducing or preventing proteolytic fermentation in the gastro-intestinal tract of a subject.

Also the invention concerns a combination of galacto-oligosaccharides, fructo-oligosaccharides and fucosylated non-digestible human milk oligosaccharides for use in reducing proteobacteria, preferably proteolytic bacteria, in the gastro-intestinal tract of a subject, preferably for use in reducing bacteria of the genus Klebsiella and/or Enterobacter.

Also the invention concerns a combination of galacto-oligosaccharides, fructo-oligosaccharides and fucosylated non-digestible human milk oligosaccharides for use in reducing branched short-chain fatty acids (BSCFA) in the gastro-intestinal tract of a subject.

For some jurisdictions the invention can also be worded as the use of galacto-oligosaccharides, fructo-oligosaccharides and fucosylated non-digestible human milk oligosaccharides for the manufacture of a composition, preferably a nutritional composition, for use in reducing or preventing proteolytic fermentation in the gastro-intestinal tract of a subject.

For some jurisdictions the invention can also be worded as the use of galacto-oligosaccharides, fructo-oligosaccharides and fucosylated non-digestible human milk oligosaccharides for the manufacture of a composition, preferably a nutritional composition, for use in reducing proteobacteria, preferably proteolytic bacteria, in the gastro-intestinal tract of a subject, preferably for use in reducing bacteria of the genus Klebsiella and/or Enterobacter.

For some jurisdictions the invention can also be worded as the use of galacto-oligosaccharides, fructo-oligosaccharides and fucosylated non-digestible human milk oligosaccharides for the manufacture of a composition, preferably a nutritional composition, for use in reducing branched short-chain fatty acids (BSCFA) in the gastro-intestinal tract of a subject.

For some jurisdictions the invention can also be worded as a method for reducing or preventing proteolytic fermentation in the gastro-intestinal tract of a subject by administering a combination of galacto-oligosaccharides, fructo-oligosaccharides and fucosylated non-digestible human milk oligosaccharides to the subject.

For some jurisdictions the invention can also be worded as a method for reducing proteobacteria, preferably proteolytic bacteria, in the gastro-intestinal tract of a subject, preferably reducing proteobacteria, preferably proteolytic bacteria, of the genus Klebsiella and/or Enterobacter, by administering a combination of galacto-oligosaccharides, fructo-oligosaccharides and fucosylated non-digestible human milk oligosaccharides to the subject.

For some jurisdictions the invention can also be worded as a method for reducing branched short-chain fatty acids (BSCFA) in the gastro-intestinal tract of a subject by administering a combination of galacto-oligosaccharides, fructo-oligosaccharides and fucosylated non-digestible human milk oligosaccharides to the subject.

In one embodiment reducing or preventing proteolytic fermentation in the gastro-intestinal tract of a subject is considered to be non-therapeutic. Hence in one embodiment, the present invention concern a non-therapeutic method for reducing or preventing proteolytic fermentation in the gastro-intestinal tract of a subject by administering a combination of galacto-oligosaccharides, fructo-oligosaccharides and fucosylated non-digestible human milk oligosaccharides to the subject.

In one embodiment reducing proteobacteria, preferably proteolytic bacteria, in the gastro-intestinal tract of a subject, preferably reducing proteobacteria, preferably proteolytic bacteria, of the genus Klebsiella and/or Enterobacter, is considered to be non-therapeutic. Hence in one embodiment, the present invention concern a non-therapeutic method for reducing proteobacteria, preferably proteolytic bacteria, in the gastro-intestinal tract of a subject, preferably reducing proteobacteria, preferably proteolytic bacteria, of the genus Klebsiella and/or Enterobacter, by administering a combination of galacto-oligosaccharides, fructo-oligosaccharides and fucosylated non-digestible human milk oligosaccharides to the subject.

In one embodiment reducing branched short-chain fatty acids (BSCFA) in the gastro-intestinal tract of a subject is considered to be non-therapeutic. Hence in one embodiment, the present invention concern a non-therapeutic method for reducing branched short-chain fatty acids (BSCFA) in the gastro-intestinal tract of a subject by administering a combination of galacto-oligosaccharides, fructo-oligosaccharides and fucosylated non-digestible human milk oligosaccharides to the subject.

### Proteolytic Fermentation

Proteolytic fermentation is the process in which proteins and/or peptides are anaerobically broken down by microorganisms. Proteolytic fermentation is alternatively named protein fermentation or protein putrefaction or putrefaction or putrefactive fermentation. In mammals proteolytic fermentation occurs in the gastro-intestinal tract, more specifically in the small intestine and/or in the large intestine (or colon), most specifically in the large intestine.

During proteolytic fermentation proteins and peptides are broken down by the microbiota present. The breakdown may occur through several metabolic pathways, including partial extracellular breakdown by microbial extracellular proteases and/or peptidases and/or endogenous (mammalian) proteases and peptidases. The resulting amino acids may be taken up by the microorganisms and serve as an energy source and/or building block. Consequently upon exposure to proteins and/or peptidases the composition of the microbiome unfavourably shifts towards proteobacteria, preferably proteolytic bacteria. Therefore an increased level of proteobacteria, preferably proteolytic bacteria, in the gastro-intestinal tract is considered an indicator of increased proteolytic fermentation, or the other way around a reduced level of proteobacteria, preferably proteolytic bacteria, in the gastro-intestinal tract is considered an indicator of reduced proteolytic fermentation.

The peptidases and/or proteases (both endogenous as microbial) involved in proteolytic fermentation may lead to discomfort or even disorders in the gastro-intestinal tract. It is known that peptidases and/or proteases in the gastro-intestinal tract can lead to inflammatory and/or immune responses. This is especially disadvantageous for infants as their gastro-intestinal tract is under development.

In case proteolytic fermentation takes place in the colon proteins and/or peptides that are not fully digested and/or fermented in the small intestine leave the ileum and enter the large intestine. As no body-own protein digestive mechanism is present in the colon, any further breakdown of the proteins and/or peptides is by proteolytic fermentation. Proteolytic breakdown products may be taken up by regular colonic absorbance or leave the body through the stool.

Typically saccharolytic fermentation is more dominant in the proximal colon compared to the distal colon, as the carbohydrates get depleted when passing through the colon.

### Proteolytic Species

The microbiota in the intestinal tract of a subject adapts towards the nutrients provided. There is a wide range of microorganisms residing in the intestinal tract that are capable of proteolytic fermentation which are proteolytic microorganisms. In case the microorganisms are bacteria, proteobacteria, in particular proteolytic bacteria, are bacteria capable of proteolytic fermentation. In the context of the present invention, proteobacteria, preferably proteolytic bacteria, may be a proteobacterial, preferably proteolytic bacterial, subspecies or genus. The proteobacteria, preferably proteolytic bacteria, may also be any combination of proteobacterial, preferably proteolytic bacterial, subspecies or genera.

Reducing or preventing proteolytic fermentation in the gastro-intestinal tract of a subject is beneficial for that subject. In the context of the present invention reducing or preventing proteolytic fermentation is compared to control which is the proteolytic fermentation in a subject that has not been administered the combination of galacto-oligosaccharides, fructo-oligosaccharides and fucosylated non-digestible human milk oligosaccharides. Preferably the reduction of proteolytic fermentation is at least 10% compared to control, more preferably at least 20% compared to control, more preferably at least 40% compared to control, more preferably at least 60% compared to control.

Suitably the proteolytic fermentation can be determined by determining the abundance of proteobacteria, preferably proteolytic bacteria, in the gastro-intestinal tract. Hence in one embodiment, a reduction of proteolytic fermentation is a reduction of proteobacteria, preferably proteolytic bacteria. In the context of the present invention reducing proteobacteria, preferably proteolytic bacteria, is compared to control which is the occurrence of proteobacteria, preferably proteolytic bacteria, in a subject that has not been administered the combination of galacto-oligosaccharides, fructo-oligosaccharides and fucosylated non-digestible human milk oligosaccharides. Preferably the reduction of proteobacteria, preferably proteolytic bacteria, is at least 10% compared to control, more preferably at least 20% compared to control, more preferably at least 40% compared to control, more preferably at least 60% compared to control.

Reducing proteobacteria, preferably proteolytic bacteria, in the gastro-intestinal tract of a subject is beneficial for that subject. In the context of the present invention reducing proteobacteria, preferably proteolytic bacteria, is compared to control which is the occurrence of proteobacteria, preferably proteolytic bacteria, in a subject that has not been administered the combination of galacto-oligosaccharides, fructo-oligosaccharides and fucosylated non-digestible human milk oligosaccharides. Preferably the reduction of proteobacteria, preferably proteolytic bacteria, is at least 10% compared to control, more preferably at least 20% compared to control, more preferably at least 40% compared to control, more preferably at least 60% compared to control.

In one embodiment the proteolytic genus Klebsiella or the proteolytic genus Enterobacter or both are reduced in the gastro-intestinal tract of a subject. Klebsiella is a bacterial genus and all species are facultative anaerobic, gram-negative. Klebsiella is a common inhabitant of the colon but also is known to be opportunistic human pathogen outside the colon. Augmented colonic presence of Klebsiella has been associated with Crohn's disease, intestinal inflammation, inflammatory bowel disease and colon cancer.

Enterobacter is a bacterial genus and all species are facultative anaerobic, gram-negative. Enterobacter is a common inhabitant of the colon but also is known to be opportunistic human pathogen outside the colon. Augmented colonic presence of Enterobacter has been associated with obesity and colon cancer.

Preferably the reducing or preventing of proteolytic fermentation is accompanied by reducing proteobacteria, preferably proteolytic bacteria, in the gastro-intestinal tract of a subject, preferably by reducing Klebsiella or Enterobacter or both.

### Branched Short Chain Fatty Acids

Short chain fatty acids (SCFAs) are fatty acids with less than six carbon atoms and are the end products of fermentation of non-digestible carbohydrates and proteins in the large intestine by anaerobic intestinal microbiota. Acetate, propionate and butyrate are the most dominantly SCFAs present in the colon. Branched short chain fatty acids (BSCFAs) such as iso-butyrate and iso-valerate are generated by fermentation of branched amino acids, such as valine, leucine and isoleucine. Due to the fact that in the gastro-intestinal tract BSCFAs are exclusively produced through proteolytic fermentation, these molecules are markers for proteolytic fermentation (Windey et al., Mol. Nutr. Food Res. 2012, 56, 184-196). A reduction in BSCFAs in the colon is directly linked to a reduction in proteolytic fermentation.

In one embodiment, the combination according to the invention reduces BSCFA in the gastro-intestinal tract of a subject, preferably reduces iso-butyrate and/or iso-valerate, most preferably reduces iso-butyrate. Preferably the reduction of BSCFA in the gastro-intestinal tract of a subject is accompanied by a reduction or prevention of proteolytic fermentation in the gastro-intestinal tract of a subject.

### Non-Digestible Oligosaccharides

According to the present invention, non-digestible oligosaccharides were found to reduce or prevent proteolytic fermentation in the gastro-intestinal tract of a subject, to reduce proteobacteria, preferably proteolytic bacteria, in the gastro-intestinal tract of a subject and/or to reduce BSCFA in the gastro-intestinal tract of a subject. A combination of galacto-oligosaccharides and fructo-oligosaccharides and fucosylated non-digestible human milk oligosaccharide was found especially suitable for these effects.

Non-digestible oligosaccharides (NDOs) are indigestible sugar-type compounds. These compounds pass through the first part of the gastro-intestinal tract substantially without being digested. In the intestine these compounds are fermented by the microbiota releasing, amongst others, short chain fatty acids which are adsorbed by the human body. The NDO are preferably not or only partially digested in the intestine by the action of acids or digestive enzymes present in the human upper digestive tract and are fermented by the human intestinal microbiota. For example, sucrose, lactose, maltose and the common maltodextrins are considered digestible.

### Galacto-Oligosaccharides (GOS) and Fructo-Oligosaccharides (FOS)

The present combination comprises galacto-oligosaccharides (GOS) and fructo-oligosaccharides (FOS).

The GOS are preferably selected from the group consisting of betagalacto-oligosaccharides, alphagalacto-oligosaccharides, and galactan. According to a preferred embodiment GOS are betagalacto-oligosaccharides. Preferably the GOS comprise galacto-oligosaccharides with beta(1,4), beta(1,3) and/or beta(1,6) glycosidic bonds and a terminal glucose. Transgalacto-oligosaccharides is for example available under the trade name Vivinal®GOS (Domo FrieslandCampina Ingredients), Bi2muno (Clasado), Cup-oligo (Nissin Sugar), Oligomate55 (Yakult), Promovita (Dairy Crest), Bioligo (Ingredion).

Fructo-oligosaccharides may in other context have names like fructopolysaccharides, oligofructose, polyfructose, polyfructan, inulin, levan and fructan and may refer to oligosaccharides comprising beta-linked fructose units, which are preferably linked by beta(2,1) and/or beta(2,6) glycosidic linkages, and a preferable DP between 2 and 200. Preferably, the fructo-oligosaccharides contain a terminal beta(2,1) glycosidic linked glucose. Preferably, the fructo-oligosaccharides contain at least 7 beta-linked fructose units. In a further preferred embodiment inulin is used. Inulin is a type of fructo-oligosaccharides wherein at least 75% of the glycosidic linkages are beta(2,1) linkages. Typically, inulin has an average chain length between 8 and 60 monosaccharide units. A suitable fructo-oligosaccharides for use in the combination of the present invention is commercially available under the trade name Raftiline®HP (Orafti). Other suitable sources are Raftilose (Orafti), Fibrulose and Fibruline (Cosucra) and Frutafit and Frutalose (Sensus).

The present combination comprises a mixture of GOS and FOS. Preferably the mixture of GOS and FOS is present in a weight ratio of from 1/99 to 99/1, more preferably from 1/19 to 19/1, more preferably from 1/1 to 19/1, more preferably from 2/1 to 15/1, more preferably from 5/1 to 12/1, even more preferably from 8/1 to 10/1, even more preferably in a ratio of about 9/1. This weight ratio is particularly advantageous when the GOS have a low average DP and FOS have a relatively high DP. Preferably the GOS are short-chain galacto-oligosaccharides (scGOS) and the FOS are long-chain fructo-oligosaccharides (IcFOS). Most preferred is a mixture of GOS with an average DP below 10, preferably below 6, and FOS with an average DP above 7, preferably above 11, even more preferably above 20. Preferably the GOS have an average DP in the range from 3-7 and the FOS have an average DP in the range from 20-40. In this embodiment it is further preferred that the GOS and FOS are present in a weight ratio in the range from 5:1 to 12:1, preferably in a weight ratio of from 8:1 to 10:1.

### Human Milk Oligosaccharides

Human milk is the preferred food for infants and is also denoted as the golden standard. Human milk contains a particularly high level of oligosaccharides of roughly 10 g/L, which is typically much more than the level of NDO in the milk from domestic animals. Also, compared to the NDOs in the milk of domestic animals, HMOs are structurally different. Human NDOs are very complex and consist of a heterogenic group of more than 130 different compounds with a diverse sugar composition. Because of their complex and polymorphic structure, large-scale synthesis is complicated. It is therefore not yet technically and economically feasible to prepare compositions, such as infant formulas, with NDO composition identical to human milk. In the combination for use according to the present invention, fucosylated non-digestible human milk oligosaccharides are included.

### Fucosylated Non-Digestible Human Milk Oligosaccharides

Fucosyllactose (FL) is a fucosylated non-digestible oligosaccharide present in human milk. It is not present in bovine milk. It consists of three monosaccharide units, fucose, galactose and glucose linked together. Lactose is a galactose unit linked to a glucose unit via a beta 1,4 linkage. A fucose unit is linked to a galactose unit of a lactose molecule via an alpha 1,2 linkage (2′-fucosyllactose, 2′-FL) or via an alpha 1,3 linkage to the glucose unit of a lactose (3-Fucosyllactose, 3-FL). 2′-FL is the most abundant NDO in human milk. The HMO used in the current invention is most preferably 2′-FL.

2′-FL, (β-L-Fuc-(1→2)-β-D-Gal-(1→4)-D-Glc) and 3-FL (β-L-Fuc-(1→3)-[β-D-Gal-(1→4)]-D-Glc), are commercially available for instance from Sigma-Aldrich. Alternatively, they can be isolated from human milk, for example as described in Andersson & Donald, 1981, J Chromatogr. 211:170-1744, or produced by genetically modified micro-organisms, for example as described in Albermann et al, 2001, Carbohydrate Res. 334:97-103.

The combination for use according to the present invention preferably comprises a weight ratio of GOS plus FOS to fucosylated non-digestible human milk oligosaccharides in the range from 100:1 to 1:1, more preferably in the range from 80:1 to 1:1, preferably in the range from 60:1 to 1:1, more preferably in the range from 40:1 to 1:1, more preferably in the range from 20:1 to 1:1, more preferably in the range from 10:1 to 1:1, more preferably in the range from 100:1 to 4:1, more preferably in the range from 80:1 to 4:1, preferably in the range from 60:1 to 4:1, more preferably in the range from 40:1 to 4:1, more preferably in the range from 20:1 to 4:1, more preferably in the range from 10:1 to 4:1, more preferably in the range from 100:1 to 6:1, more preferably in the range from in the range from 80:1 to 6:1, preferably in the range from 60:1 to 6:1, more preferably in the range from 40:1 to 6:1, more preferably in the range from 20:1 to 6:1, more preferably in the range from 10:1 to 6:1. Preferably the GOS have an average DP in the range from 3-7 and the FOS have an average DP in the range from 20-40. In this embodiment it is further preferred that the GOS and FOS are present in a weight ratio in the range from 5:1 to 12:1, preferably in a weight ratio of from 8:1 to 10:1.

The combination for use according to the present invention preferably comprises a weight ratio of GOS plus FOS to 2′-FL in the range from 100:1 to 1:1, more preferably in the range from 80:1 to 1:1, preferably in the range from 60:1 to 1:1, more preferably in the range from 40:1 to 1:1, more preferably in the range from 20:1 to 1:1, more preferably in the range from 10:1 to 1:1, more preferably in the range from 100:1 to 4:1, more preferably in the range from 80:1 to 4:1, preferably in the range from 60:1 to 4:1, more preferably in the range from 40:1 to 4:1, more preferably in the range from 20:1 to 4:1, more preferably in the range from 10:1 to 4:1, more preferably in the range from 100:1 to 6:1, more preferably in the range from in the range from 80:1 to 6:1, preferably in the range from 60:1 to 6:1, more preferably in the range from 40:1 to 6:1, more preferably in the range from 20:1 to 6:1, more preferably in the range from 10:1 to 6:1. Preferably the GOS have an average DP in the range from 3-7 and the FOS have an average DP in the range from 20-40. In this embodiment it is further preferred that the GOS and FOS are present in a weight ratio in the range from 5:1 to 12:1, preferably in a weight ratio of from 8:1 to 10:1.

Non-digestible oligosaccharides other than GOS, FOS and fucosylated non-digestible human milk oligosaccharides In one embodiment, the nutritional composition further comprises NDOs other than GOS, FOS and fucosylated non-digestible human milk oligosaccharides. Such other NDOs are preferably selected from the group consisting of xylo-oligosaccharides, arabino-oligosaccharides, arabinogalacto-oligosaccharides, gluco-oligosaccharides, chito-oligosaccharides, glucomanno-oligosaccharides, galactomanno-oligosaccharides, mannan-oligosaccharides, N-acetylated oligosaccharides, and sialylated oligosaccharides. The other NDOs stimulates the formation of a healthy intestinal microbiota.

### Nutritional Composition

The combination of GOS, FOS and fucosylated non-digestible human milk oligosaccharides for use according to the present invention is preferably comprised in a nutritional composition. Hereafter the combination of GOS, FOS and fucosylated non-digestible human milk oligosaccharides comprised in a nutritional composition is also referred to as the nutritional composition for use according to the invention or the nutritional composition according to the invention or the present nutritional composition.

The present nutritional composition comprises preferably 0.5 to 20 wt % of the combination of GOS, FOS and fucosylated non-digestible human milk oligosaccharides, more preferably 1.5 to 15 wt %, even more preferably 2.5 to 12 wt %, most preferably 5.0 to 10.0 wt %, based on dry weight of the nutritional composition. Based on 100 ml the present nutritional composition preferably comprises 0.35 to 2.5 wt % combination of GOS, FOS and fucosylated non-digestible human milk oligosaccharides, more preferably 0.35 to 2.0 wt %, even more preferably 0.4 to 1.5 wt %, based on 100 ml of the nutritional composition. A lower amount of the combination will be less effective in reducing and/or preventing proteolytic fermentation, whereas a too high amount will result in side-effects of bloating and abdominal discomfort.

Preferably, the present nutritional composition comprises 1 mg to 3 g fucosyllactose per 100 ml, more preferably 10 mg to 2 g, more preferably 20 mg to 1 g, even more preferably 20 mg to 500 mg FL, even more preferably 50 mg to 500 mg FL per 100 ml. Based on dry weight, the present nutritional composition preferably comprises 0.005 wt % to 20 wt % fucosyllactose, more preferably 0.07 wt % to 10 wt %, more preferably 0.15 wt % to 5 wt %, more preferably 0.15 wt % to 3 wt %. Preferably, the present nutritional composition comprises 1 mg to 3 g 2′-FL per 100 ml, more preferably 10 mg to 2 g, more preferably 20 mg to 1 g, even more preferably 20 mg to 500 mg FL, even more preferably 50 mg to 500 mg FL per 100 ml. Based on dry weight, the present nutritional composition preferably comprises 0.005 wt % to 20 wt % 2′-FL, more preferably 0.07 wt % to 10 wt %, more preferably 0.15 wt % to 5 wt %, more preferably 0.15 wt % to 3 wt % 2′-FL. A lower amount of fucosyllactose will be less effective in reducing proteolytic fermentation, whereas a too high amount will result in unnecessary high costs of the product. In one embodiment, the fucosylated non-digestible human milk oligosaccharide for use according to the present invention consists of fucosyllactose. In one embodiment, the fucosylated non-digestible human milk oligosaccharide for use according to the present invention consists of 2′-fucosyllactose.

The present nutritional composition is preferably an infant formula, follow on formula, toddler milk or toddler formula, or growing up milk intended for young children, preferably an infant formula or follow on formula. The present nutritional composition can be advantageously applied as a complete nutrition for infants. Preferably the present nutritional composition is an infant formula. An infant formula is defined as a formula for use in infants and can for example be a starter formula, intended for infants of 0 to 6 or 0 to 4 months of age. A follow on formula is intended for infants of 4 or 6 months to 12 months of age. At this age infants start weaning on other food. A toddler or growing up milk or formula is intended for children of 12 to 36 months of age. The present nutritional composition preferably comprises a lipid component, protein component and carbohydrate component and is preferably administered in liquid form. The present nutritional composition may also be in the form of a dry food, preferably in the form of a powder which is accompanied with instructions as to mix said dry food, preferably powder, with a suitable liquid, preferably water. The present nutritional composition preferably comprises other fractions, such as vitamins, minerals, trace elements and other micronutrients in order to make it a complete nutritional composition. Preferably infant formulas comprise vitamins, minerals, trace elements and other micronutrients according to international directives.

The present nutritional composition preferably comprises lipid, protein and digestible carbohydrate wherein the lipid provides 5 to 50% of the total calories, the protein provides 5 to 50% of the total calories, and the digestible carbohydrate provides 15 to 90% of the total calories. Preferably, in the present nutritional composition the lipid provides 35 to 50% of the total calories, the protein provides 7.0 to 12.5% of the total calories, and the digestible carbohydrate provides 40 to 55% of the total calories. For calculation of the % of total calories for the protein, the total of energy provided by proteins, peptides and amino acids needs to be taken into account. Preferably the lipid provides 3 to 7 g lipid per 100 kcal, preferably 4 to 6 g per 100 kcal, the protein provides 1.6 to 4 g per 100 kcal, preferably 1.7 to 2.5 g per 100 kcal and the digestible carbohydrate provides 5 to 20 g per 100 kcal, preferably 8 to 15 g per 100 kcal of the nutritional composition. Preferably the present nutritional composition comprises lipid providing 4 to 6 g per 100 kcal, protein providing 1.6 to 2.0 g per 100 kcal, more preferably 1.7 to 1.9 g per 100 kcal and digestible carbohydrate providing 8 to 15 g per 100 kcal of the nutritional composition. In one embodiment, the lipid provides 3 to 7 g lipid per 100 kcal, preferably 4 to 6 g per 100 kcal, the protein provides 1.6 to 2.1 g per 100 kcal, preferably 1.6 to 2.0 g per 100 kcal and the digestible carbohydrate provides 5 to 20 g per 100 kcal, preferably 8 to 15 g per 100 kcal of the nutritional composition and wherein preferably the digestible carbohydrate component comprises at least 60 wt % lactose based on total digestible carbohydrate, more preferably at least 75 wt %, even more preferably at least 90 wt % lactose based on total digestible carbohydrate. The amount of total calories is determined by the sum of calories derived from protein, lipids, digestible carbohydrates and non-digestible oligosaccharide.

The present nutritional composition preferably comprises a digestible carbohydrate component. Preferred digestible carbohydrate components are lactose, glucose, sucrose, fructose, galactose, maltose, starch and maltodextrin. Lactose is the main digestible carbohydrate present in human milk. The present nutritional composition preferably comprises lactose. Preferably the present nutritional composition does not comprise high amounts of carbohydrates other than lactose. Compared to digestible carbohydrates such as maltodextrin, sucrose, glucose, maltose and other digestible carbohydrates with a high glycemic index, lactose has a lower glycemic index and is therefore preferred. The present nutritional composition preferably comprises digestible carbohydrate, wherein at least 35 wt %, more preferably at least 50 wt %, more preferably at least 60 wt %, more preferably at least 75 wt %, even more preferably at least 90 wt %, most preferably at least 95 wt % of the digestible carbohydrate is lactose. Based on dry weight the present nutritional composition preferably comprises at least 25 wt % lactose, preferably at least 40 wt %, more preferably at least 50 wt % lactose.

The present nutritional composition preferably comprises at least one lipid selected from the group consisting of animal lipid (excluding human lipids) and vegetable lipids. Preferably the present nutritional composition comprises a combination of vegetable lipids and at least one oil selected from the group consisting of fish oil, animal oil, algae oil, fungal oil, and bacterial oil. The lipid of the present nutritional composition preferably provides 3 to 7 g per 100 kcal of the nutritional composition, preferably the lipid provides 4 to 6 g per 100 kcal. When in liquid form, e.g. as a ready-to-feed liquid, the nutritional composition preferably comprises 2.1 to 6.5 g lipid per 100 ml, more preferably 3.0 to 4.0 g per 100 ml. Based on dry weight the present nutritional composition preferably comprises 12.5 to 40 wt % lipid, more preferably 19 to 30 wt %. Preferably the lipid comprises the essential fatty acids alpha-linolenic acid (ALA), linoleic acid (LA) and/or long chain polyunsaturated fatty acids (LC-PUFA). The LC-PUFA, LA and/or ALA may be provided as free fatty acids, in triglyceride form, in diglyceride form, in monoglyceride form, in phospholipid form, or as a mixture of one of more of the above. Preferably the present nutritional composition comprises at least one, preferably at least two lipid sources selected from the group consisting of rape seed oil (such as colza oil, low erucic acid rape seed oil and canola oil), high oleic sunflower oil, high oleic safflower oil, olive oil, marine oils, microbial oils, coconut oil, palm kernel oil. The present nutritional composition is not human milk.

The present nutritional composition preferably comprises protein. The protein used in the nutritional composition is preferably selected from the group consisting of non-human animal proteins, preferably milk proteins, vegetable proteins, such as preferably soy protein and/or rice protein, and mixtures thereof. The present nutritional composition preferably contains casein, and/or whey protein, more preferably bovine whey proteins and/or bovine casein. Thus in one embodiment the protein in the present nutritional composition comprises protein selected from the group consisting of whey protein and casein, preferably whey protein and casein, preferably the whey protein and/or casein is from cow's milk. Preferably the protein comprises less than 5 wt % based on total protein of free amino acids, dipeptides, tripeptides or hydrolyzed protein. The present nutritional composition preferably comprises casein and whey proteins in a weight ratio casein:whey protein of 10:90 to 90:10, more preferably 20:80 to 80:20, even more preferably 35:65 to 55:45.

The wt % protein based on dry weight of the present nutritional composition is calculated according to the Kjeldahl-method by measuring total nitrogen and using a conversion factor of 6.38 in case of casein, or a conversion factor of 6.25 for other proteins than casein. The term ‘protein’ or ‘protein component’ as used in the present invention refers to the sum of proteins, peptides and free amino acids.

The present nutritional composition preferably comprises protein providing 1.6 to 4.0 g protein per 100 kcal of the nutritional composition, preferably providing 1.6 to 3.5 g, even more preferably 1.75 to 2.5 g per 100 kcal of the nutritional composition. In one embodiment, the present nutritional composition comprises protein providing 1.6 to 2.1 g protein per 100 kcal of the nutritional composition, preferably providing 1.6 to 2.0 g, more preferably 1.75 to 2.1 g, even more preferably 1.75 to 2.0 g per 100 kcal of the nutritional composition. In one embodiment, the present nutritional composition comprises protein in an amount of less than 2.0 g per 100 kcal, preferably providing 1.6 to 1.9 g, even more preferably 1.75 to 1.85 g per 100 kcal of the nutritional composition. A too low protein content based on total calories will result is less adequate growth and development in infants and young children. A too high amount will put a metabolic burden, e.g. on the kidneys of infants and young children. When in liquid form, e.g. as a ready-to-feed liquid, the nutritional composition preferably comprises 0.5 to 6.0 g, more preferably 1.0 to 3.0 g, even more preferably 1.0 to 1.5 g protein per 100 ml, most preferably 1.0 to 1.3 g protein per 100 ml. Based on dry weight the present nutritional composition preferably comprises 5 to 20 wt % protein, preferably at least 8 wt % protein based on dry weight of the total nutritional composition, more preferably 8 to 14 wt %, even more preferably 8 to 9.5 wt % protein based on dry weight of the total nutritional composition.

In order to meet the caloric requirements of an infant or toddler, the nutritional composition preferably comprises 45 to 200 kcal/100 ml liquid. For infants the nutritional composition has more preferably 60 to 90 kcal/100 ml liquid, even more preferably 65 to 75 kcal/100 ml liquid. This caloric density ensures an optimal ratio between water and calorie consumption. For toddlers, human subjects with an age between 12 and 36 months, the nutritional composition more preferably has a caloric density between 45 and 65, even more preferably between 50 and 60 kcal/100 ml. The osmolarity of the present composition is preferably between 150 and 420 mOsmol/l, more preferably 260 to 320 mOsmol/l. The low osmolarity aims to further reduce the gastro-intestinal stress.

When the nutritional composition is in a ready to feed, liquid form, the preferred volume administered on a daily basis is in the range of about 80 to 2500 ml, more preferably about 200 to 1200 ml per day. Preferably, the number of feedings per day is between 1 and 10, preferably between 3 and 8. In one embodiment the nutritional composition is administered daily for a period of at least 2 days, preferably for a period of at least 4 weeks, preferably for a period of at least 8 weeks, more preferably fora period of at 25 least 12 weeks, in a liquid form wherein the total volume administered daily is between 200 ml and 1200 ml and wherein the number of feedings per day is between 1 and 10.

The present nutritional composition, when in liquid form, preferably has a viscosity between 1 and 60 mPa·s, preferably between 1 and 20 mPa·s, more preferably between 1 and 10 mPa·s, most preferably between 1 and 6 mPa·s. The low viscosity ensures a proper administration of the liquid, e.g. a proper passage through the whole of a nipple. Also this viscosity closely resembles the viscosity of human milk. Furthermore, a low viscosity results in a normal gastric emptying and a better energy intake, which is essential for infants which need the energy for optimal growth and development. The present nutritional composition alternatively is in powder form, suitable for reconstitution with water to a ready to drink liquid. The present nutritional composition is preferably prepared by admixing a powdered composition with water. Normally infant formula is prepared in such a way. The present invention thus also relates to a packaged power composition wherein said package is provided with instructions to admix the powder with a suitable amount of liquid, thereby resulting in a liquid composition with a viscosity between 1 and 60 mPa·s. The viscosity of the liquid is determined using a Physica Rheometer MCR 300 (Physica Messtechnik GmbH, Ostfilden, Germany) at a shear rate of 95 s⁻¹ at 20° C.

### Application

It has surprisingly been found that a combination of galacto-oligosaccharides (GOS) and fructo-oligosaccharides (FOS) and fucosylated non-digestible human milk oligosaccharides, preferably fucosyllactose, more preferably 2′-fucosyllactose (2′-FL) reduces or prevents proteolytic fermentation in the gastro-intestinal tract of a subject. Detrimental effects related to proteolytic fermentation are therewith reduced of prevented. Hence in one aspect, the combination of galacto-oligosaccharides (GOS) and fructo-oligosaccharides (FOS) and fucosylated non-digestible human milk oligosaccharides is used for reducing or preventing proteolytic fermentation in the gastro-intestinal tract of a subject. Preferably the reducing or preventing proteolytic fermentation occurs in the colon, more preferably the proximal colon.

As proteolytic fermentation in the gastro-intestinal tract of a subject can lead to inflammatory and/or immune responses, the present invention also concerns reducing or reducing the risk of or preventing inflammatory and/or immune responses in a subject, by reducing or preventing proteolytic fermentation in the gastro-intestinal tract of a subject by administering a combination of galacto-oligosaccharides (GOS) and fructo-oligosaccharides (FOS) and fucosylated non-digestible human milk oligosaccharides, preferably comprised in a nutritional composition, as defined herein.

Also it has surprisingly been found that a combination of galacto-oligosaccharides (GOS) and fructo-oligosaccharides (FOS) and fucosylated non-digestible human milk oligosaccharides, preferably fucosyllactose, more preferably 2′-fucosyllactose (2′-FL) the amount of proteobacteria, preferably proteolytic bacteria, is greatly reduced in the gastro-intestinal tract of a subject. Hence in one aspect, the combination of galacto-oligosaccharides (GOS) and fructo-oligosaccharides (FOS) and fucosylated non-digestible human milk oligosaccharides is used for reducing proteobacteria, preferably proteolytic bacteria, in the gastro-intestinal tract of a subject, preferably for use in reducing bacteria of the genus Klebsiella and/or Enterobacter. Preferably the reducing proteobacteria, preferably proteolytic bacteria, occurs in the colon, more preferably the proximal colon.

As proteolytic fermentation in the gastro-intestinal tract of a subject can lead to inflammatory and/or immune responses, the present invention also concerns reducing or reducing the risk of or preventing inflammatory and/or immune responses in a subject, by reducing proteobacteria, preferably proteolytic bacteria, in the gastro-intestinal tract of a subject by administering a combination of galacto-oligosaccharides (GOS) and fructo-oligosaccharides (FOS) and fucosylated non-digestible human milk oligosaccharides, preferably comprised in a nutritional composition, as defined herein.

Moreover it has also been found that the level of the branched short-chain fatty acid iso-butyrate, an exclusive metabolite of proteolytic fermentation is reduced considerably. Hence in one aspect, the combination of galacto-oligosaccharides (GOS) and fructo-oligosaccharides (FOS) and fucosylated non-digestible human milk oligosaccharides is used for reducing branched short-chain fatty acids (BSCFA) in the gastro-intestinal tract of a subject. Preferably the reducing of BSCFA occurs in the colon, more preferably the distal colon.

When combining fucosylated non-digestible human milk oligosaccharide with a GOS/FOS mixture, the effect on proteolytic fermentation and on the level of proteobacteria, preferably proteolytic bacteria, is larger than the effect of the GOS/FOS mixture alone, especially with regard to iso-butyrate formation and Klebsiella and/or Enterobacter reduction.

Preferably the combination of galacto-oligosaccharides (GOS) and fructo-oligosaccharides (FOS) and fucosylated non-digestible human milk oligosaccharides is in a form, preferably comprised in a nutritional composition, that is suitable for, or suitable for administration to, a human subject. In one embodiment, the present nutritional composition is suitable for infants and/or young children. In one embodiment the present nutritional composition is for use in providing nutrition to human subjects with an age of 0 to 36 months. Young children, or toddlers, are defined as human subjects with an age of 12 to 36 months. Infants are defined as human subjects with an age of below 12 months. So in other words, the present nutritional composition is suitable for human subjects with an age of 0 to 36 months. Wherever in this description the term “infants and/or young children” is used, this can be replaced by “human subjects with an age of 0 to 36 months”. Preferably the present nutritional composition is suitable for a human subject with an age of 0 months to 12 months. These infants have a still developing intestinal tract and therefore are in need of a reduction of proteolytic fermentation. Moreover the microbiome of these infants is not fully developed, and reducing proteolytic fermentation supports the development of a healthy microbiome. In a preferred embodiment, the nutritional composition for use according to the present invention is for use in an infant that is born via caesarean section, also referred to as C-section infants. As in C-section infants the development of a healthy microbiome is delayed due to the sterile conditions at birth, these infants are in particular need of reducing or preventing proteolytic fermentation and reducing proteobacteria, preferably proteolytic bacteria, in the gastro-intestinal tract.

Preterm infants have an even less developed intestinal tract. Preterm infants, defined as infants born before week 37 of gestation, preferably before week 32, are therefore in particular need of reduced proteolytic fermentation in the gastro-intestinal tract. In a preferred embodiment, the present nutritional composition is suitable for a preterm infant, preferably for a preterm infant born before week 37 of gestation, more preferably for a preterm infant born before week 32 of gestation.

Preferably the present nutritional composition is administered to the subject immediately after birth of the subject. Preferably the present nutritional composition is administered to the subject in the first 2 months after birth of the subject, preferably in the first 4 months after birth of the subject.

The methods according to the present invention comprising administering the present combination of galacto-oligosaccharides, fructo-oligosaccharides and fucosylated non-digestible human milk oligosaccharides or administering a nutritional composition comprising the combination of galacto-oligosaccharides, fructo-oligosaccharides and fucosylated non-digestible human milk oligosaccharides also refer to administering an effective amount of the combination of galacto-oligosaccharides, fructo-oligosaccharides and fucosylated non-digestible human milk oligosaccharides to a subject in need thereof.

The present nutritional composition is preferably enterally administered, more preferably orally.

### BRIEF DESCRIPTION OF THE FIGURES

FIG. 1 shows the production of butyrate in the distal colon of the un-supplemented (control) and supplemented SHIME® units.

FIG. 2 shows the production of iso-butyrate in the distal colon of the un-supplemented (control) and supplemented SHIME® units.

FIG. 3 shows the relative abundance of Bifidobacterium in the proximal colon.

FIG. 4 shows the relative abundance Veillonella in the proximal colon.

FIG. 5 shows the relative abundance of Proteobacteria in the proximal colon.

FIG. 6 shows the relative abundance of proteobacteria in the proximal colon of a vaginally-born infant.

### EXAMPLES

### Example 1 Combination of scGOS/IcFOS with 2′-FL Positively Impacts the Infant Gut Microbiota Composition and Metabolic Activity in a Simulator of the Human Intestinal Microbial Ecosystem) (SHIME®)

In this experiment the effect of: i) scGOS/IcFOS (ratio 9:1) mixture, ii) 2′-FL and iii) the combination of scGOS/IcFOS (ratio 9:1) and 2′-FL on the eco-physiology of the gut microbiota using the in vitro gut model SHIME® was investigated.

### Material and Methods

A faecal sample from a 3 months old healthy infant born via C-section, exclusively breastfed with no history of antibiotic usage, was used as inoculum to simulate the infant gut microbiota in the colon compartments of a quad-SHIME®, a dynamic model of the human gastro-intestinal tract comprising 4 SHIME® units running in parallel (ex ProDigest, Gent, Belgium). Each SHIME® unit is composed of 3 reactors simulating 1) the stomach and small intestine, 2) the proximal colon and 3) the distal colon.

The SHIME® units received a modified SHIME® feed, 1 un-supplemented acting as baseline control (0.5 g/L casein, 4.6 g/L whey protein, 4 g/L mucin, 1 g/L yeast extract, 0.2 g/L cysteine, 2.3 g/L glucose, 2.6 g/L lactose and 0.12 g/L galactose), and the other 3 supplemented with either 2′-FL (0.1 ‘)/0 w/v), scGOS/IcFOS (9:1) (0.8 w/v), or scGOS/IcFOS/2’-FL (0.8% w/v scGOS/IcFOS-9/1 ratio+0.1 w/v 2′-FL). The scGOS was VivinalGOS® the IcFOS was RaftilineHP®. Samples from the colon vessels were collected throughout a 2-week simulation period. Microbiota composition, short-chain fatty acids (SCFA) and glycoprofiles were analysed using 16s rRNA sequencing, gas chromatography-mass spectrometry (GCMS) and High performance anion exchange chromatography with pulsed amperometric detection (HPAEC-PAD), respectively.

### Results

### SCFA Production

Short chain fatty acid (SCFA) profiles showed that acetate is the most abundant in the distal colon, followed by propionate. The concentrations of acetate and propionate were higher in the presence of scGOS/IcFOS and scGOS/IcFOS/2′-FL than in the control and 2′-FL-supplemented units. Surprisingly replacing part of scGOS/IcFOS by 2′-FL does not decrease the amounts of acetate and propionate formed. Similar observations as for the distal colon were also seen in the proximal colons.

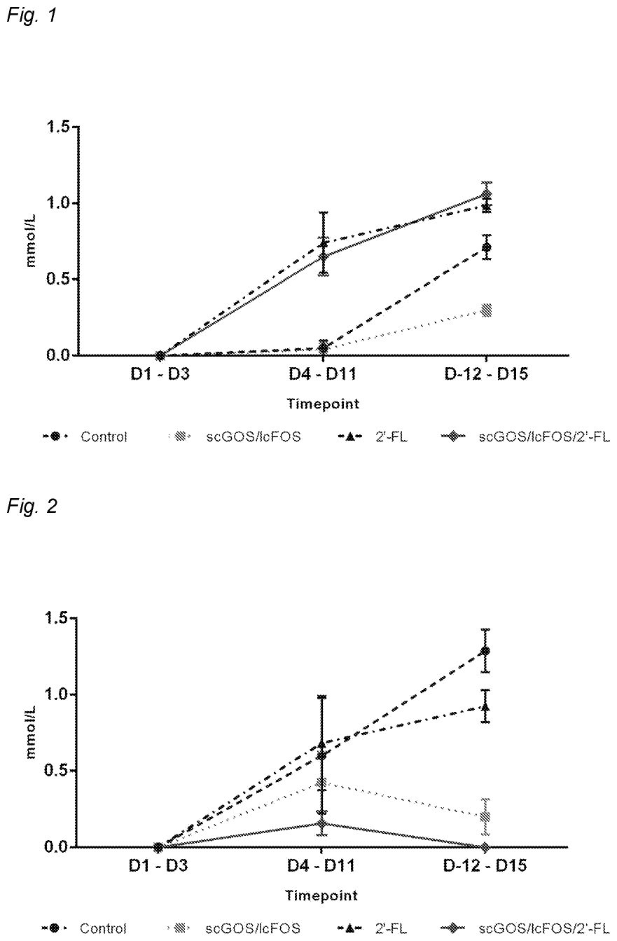

Interestingly, butyrate was generated earlier in the distal colon and at a higher concentration in the presence of 2′-FL and scGOS/IcFOS/2′-FL relative to the control and the scGOS/IcFOS groups (FIG. 1). The level of iso-butyrate, a branched SCFA resulting from the proteolytic fermentation, was surprisingly reduced in the distal colon in the presence of scGOS/IcFOS (FIG. 2). Unexpectedly replacing part of scGOS/IcFOS by 2′-FL further decreased the iso-butyrate production in the distal colon. This decrease surmounts the decrease that can be expected from the individual components. A decrease of iso-butyrate is indicative for a reduced proteolytic fermentation.

### Glycoprofile

Glycoprofiles over time were determined for each reactor of the SHIME model for the different feeds. Chromatograms (not shown) were recorded representing the proximal colon (PC) and distal colon (DC) at different time points i.e. 8 hours after previous feeding cycle (T0), after 1 hour (T1), 3 hours (T3) and 5 hours (T5) of fermentation.

The glycoprofile data revealed that 2′-FL was not used when supplemented alone but surprisingly only utilized in the presence of scGOS/IcFOS and was slowly metabolized across the proximal and distal colon. All other carbohydrates including scGOS were depleted within the first hour in the proximal colon.

### Microflora

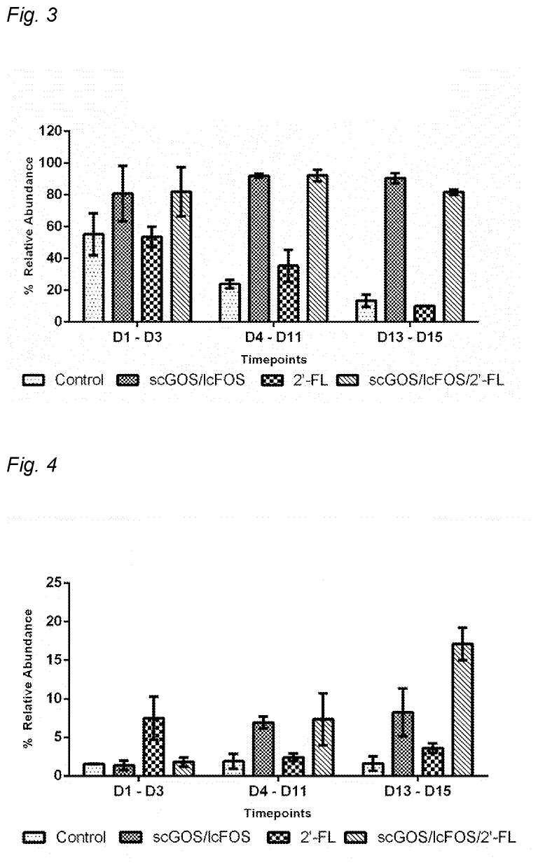

16S rRNA sequencing results showed an increase in the relative abundance of Bifidobacterium in the proximal colon when supplemented with either scGOS/IcFOS or scGOS/IcFOS/2′-FL (FIG. 3). Surprisingly replacing part of scGOS/IcFOS by 2′-FL does not decrease the relative abundance of Bifidobacterium even whilst 2′-FL demonstrates no bifidogenic effect. Similar trends were observed in the distal colons (data not shown).

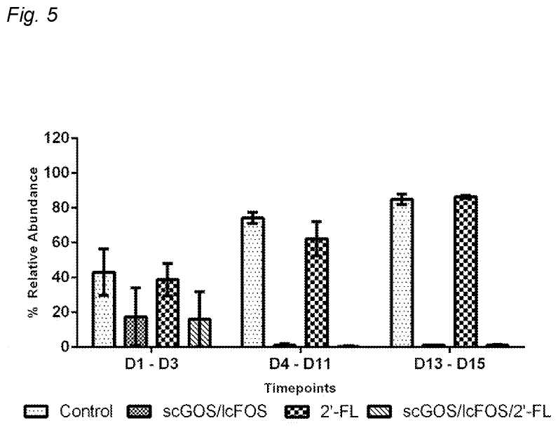

In addition, an increase in the abundance of Veillonella, a lactate-utilizing bacteria that produce propionate, was observed mainly in the scGOS/IcFOS/2′-FL group (FIG. 4). In contrast, the abundance of Proteobacteria (dominated by the Klebsiella genus) was surprisingly reduced when supplemented with scGOS/IcFOS or scGOS/IcFOS/2′-FL but not in the 2′-FL group (FIG. 5). This is indicative for a reduced proteolytic fermentation. Considering the individual effects of scGOS/IcFOS and 2′-FL the combined effect of scGOS/IcFOS/2′-FL is unexpected.

### Conclusions

From the results it follows that 2′-FL was only metabolised in the presence of scGOS/IcFOS resulting in a microbial eco-system that is suggested to confer health benefits. In particular it can be concluded that scGOS/IcFOS/2′-FL increased the level of Bifidobacterium and Veillonella and reduced potential pathogens. Moreover scGOS/IcFOS/2′-FL decreased the level of iso-butyrate which is indicative of less proteolytic activity in the colon. In fact this indication of less proteolytic activity in the colon was already observed for scGOS/IcFOS alone, so without the further presence of 2′-FL. Also it was found that scGOS/IcFOS/2′-FL enhanced the production of butyrate which is an important SCFA for the gut maturation and development. Also it may be concluded that in particular infants born via caesarean section benefit from the scGOS/IcFOS/2′-FL combination for the lower proteolytic fermentation.

### Example 2:Infant Formula

A powdered infant formula, which after reconstitution with water to a ready to feed liquid infant formula comprising per 100 ml:

about 13.7 g dry matter, 66 kcal
1.35 g protein (bovine whey protein/casein in 1/1 weight ratio), 11 wt % based on dry weight, 2.0 g/100 kcal
8.2 g digestible carbohydrate (of which 5.6 g lactose, and 2.1 g maltodextrin)
3.0 g fat (mainly vegetable fat).
0.8 g non-digestible oligosaccharides of scGOS (source Vivinal GOS) and IcFOS (source RaftilinHP) in a 9:1 weight ratio and 0.1 g 2′-fucosyllactose.

The composition further comprises vitamins, minerals, trace elements and other micronutrients according to international directive 2006/141/EC for infant formula.

The infant formula is particularly intended for infants born via C-section. Also the infant formula is intended for promoting intestinal tract health and/or is indicated for reducing proteolytic fermentation and/or reducing the undesired effects of proteolytic fermentation.

1. A non-therapeutic method for reducing or preventing proteolytic fermentation in the gastrointestinal tract of a subject by administering a combination of galacto-oligosaccharides, fructo-oligosaccharides and fucosylated non-digestible human milk oligosaccharides to the subject.

2. A non-therapeutic method for reducing proteobacteria, preferably proteolytic bacteria, in the gastro-intestinal tract of a subject, by administering a combination of galacto-oligosaccharides, fructo-oligosaccharides and fucosylated non-digestible human milk oligosaccharides to the subject.

3. A non-therapeutic method for reducing branched short-chain fatty acids (BSCFA) in the gastro-intestinal tract of a subject by administering a combination of galacto-oligosaccharides, fructo-oligosaccharides and fucosylated non-digestible human milk oligosaccharides to the subject.

4. The non-therapeutic method according to claim 3, wherein the BSCFA is iso-butyrate.

5. The non-therapeutic method according to claim 1, wherein the combination is comprised in a nutritional composition.

6. The non-therapeutic method according to claim 1, wherein the subject is an infant born via caesarean section.

7. The non-therapeutic method according to claim 1, which wherein the combination is administered to the subject in the first 2 months after birth of the subject.

8. The non-therapeutic method according to claim 1, which wherein the combination is administered to the subject immediately after birth of the subject.

9. The non-therapeutic method according to claim 1, wherein the gastro-intestinal tract is the colon.

10. The non-therapeutic method according to claim 3, wherein the gastro-intestinal tract is the colon, more preferably the distal colon.

11. The non-therapeutic method according to claim 1, wherein the fucosylated non-digestible human milk oligosaccharides comprises fucosyllactose.

12. The non-therapeutic method according to claim 1, wherein the galacto-oligosaccharides have an average degree of polymerisation in the range from 3-7 and the fructo-oligosaccharides have an average degree of polymerisation in the range from 20-40.

13. The non-therapeutic method according to claim 1, wherein the weight ratio of galacto-oligosaccharides to fructo-oligosaccharides is in the range from 5:1 and 12:1.

14. The non-therapeutic method according to claim 1, wherein the weight ratio of galacto-oligosaccharides plus fructo-oligosaccharides to fucosylated non-digestible human milk oligosaccharides is in the range from 100:1 to 1:11.

15. The non-therapeutic method according to claim 1, wherein the combination is comprised in a nutritional composition in an amount of 0.5 to 20 wt %, based on dry weight of the nutritional composition.
